(19) United States
(12) Patent Application Publication
(10) Pub. No.: US 2024/0330170 A1
(43) Pub. Date: Oct. 3, 2024

(54) VEHICLE TEST ENVIRONMENT MANAGEMENT SERVICE

(71) Applicant: Amazon Technologies, Inc., Seattle, WA (US)

(72) Inventors: Roland Mesde, Cupertino, CA (US); Alex Bessonov, San Jose, CA (US); George Sherif Kamal Hanna, Toronto (CA); Nitin Giri, Bothell, WA (US)

(73) Assignee: Amazon Technologies, Inc., Seattle, WA (US)

(21) Appl. No.: 18/194,391

(22) Filed: Mar. 31, 2023

(51) Int. Cl. G06F 11/36; B60R 16/023

(52) U.S. Cl. CPC G06F 11/3692; B60R 16/0231; G06F 11/3688

(57) ABSTRACT

A vehicle software test environment management system provides a virtual vehicle environment that includes virtual electronic control units (vECUs) having a virtual bus connectivity configuration used to simulate respective ones of electronic control units (ECUs) of a real-world vehicle. The vehicle software test environment management system determines respective instance types of one or more virtual compute instances to be used to implement the vECUs based on respective configuration of respective ones of the ECUs and further determines respective machine images to emulate respective software environments of the respective ones of the ECUs. The vehicle software test environment management system may also deploy a vehicle software application to be certified on one or more of the vECUs and test the deployed vehicle software application using recorded signals of one or more ECUs of the real-world vehicle.

### BACKGROUND

Modern vehicles, such as cars, trucks, motorcycles, etc. are often manufactured with electronic sensors and include computer systems programmed with control algorithms that take inputs from such electronic sensors to determine various control actions to be taken for the vehicle or systems implemented in the vehicles. Some vehicles may include multiple electronic control units (ECUs) and sensors having various sensor modalities. Additionally, deployment of a vehicle software application may require that the vehicle software application be tested and certified on vehicles equipped with the multiple ECUs and sensors. However, testing the vehicle software application on production vehicles may be slow or cost prohibitive.

### BRIEF DESCRIPTION OF THE DRAWINGS

FIG. 1 illustrates a vehicle software test environment management system that receives a vehicle deployment graph indicating various electronic control units (ECUs) of a vehicle and indicating a network configuration of the vehicle, wherein the vehicle software test environment management system provides instructions for implementing (or orchestrates the implementation of) virtual electronic control units (vECUs) having a virtual bus connectivity configuration that simulates that of the vehicle, wherein the configured ECUs are used in performing software certification for one or more software applications to be deployed on the vehicle, according to some embodiments.

FIG. 2A illustrates a graphical view of a vehicle software test environment management system, its various parts, and interactions to deploy a vehicle software application, for which certification is being performed, to vECUs of a virtual test vehicle having vECUs configured according to a virtual bus connectivity configuration, according to some embodiments.

FIG. 2B illustrates a graphical view of a vehicle software test environment management system, its various parts, and interactions that conduct performance of a test plan for a vehicle software application using vECUs of a virtual test vehicle having vECUs configured according to a virtual bus connectivity configuration, according to some embodiments.

FIG. 2C illustrates a graphical view of a vehicle software test environment management system, its various parts, and interactions to provide results of performance of a test plan and requesting/obtaining certification based on the received results, according to some embodiments.

FIG. 3A illustrates a more detailed view of a vehicle software test environment management system that obtains information regarding available virtual instance types and machine images and determines a virtual instance type and a machine image needed to simulate respective ECUs of the vehicle using respective vECUs, according to some embodiments.

FIG. 3B illustrates a more detailed view of a vehicle software test environment management system that provisions virtual instances having respective virtual instance types and machine images selected to simulate ECUs of a vehicle based on a vehicle deployment graph, according to some embodiments.

FIG. 3C illustrates a more detailed view of a vehicle software test environment management system that configures simulated vehicle bus interfaces of virtual instances having respective virtual instance types and machine images selected to simulate the ECUs of the vehicle in a network configuration of the vehicle according to a vehicle deployment graph, according to some embodiments.

FIG. 4 illustrates a more detailed view of a vehicle software test environment management system that provides vECUs implemented on virtual compute instances to simulate a subset of the ECUs of the vehicle for a partial simulation, according to some embodiments.

FIG. 5 illustrates a more detailed view of a vehicle software test environment management system that deploys a vehicle software application to be certified to a virtual test vehicle using an emulated over-the-air (OTA) agent of the virtual test vehicle, according to some embodiments.

FIG. 6 illustrates a more detailed view of a vehicle software test environment management system that requests/obtains certification of a vehicle software application based on test results from a virtual test vehicle and/or results from testing performed using one or more real vehicles, according to some embodiments.

FIG. 7 illustrates a flowchart of operations performed by a vehicle software test environment management system to provide virtual electronic control units (vECUs) having a virtual bus connectivity configuration determined based on a vehicle deployment graph, wherein the vECUs connected using the virtual bus connectivity configuration may be used to simulate a vehicle environment of a real-world vehicle, according to some embodiments.

FIG. 8 illustrates a flowchart of operations performed by a vehicle software test environment management system to deploy a software application to a vECU and certify the software application based on performance of a received test plan, according to some embodiments.

FIG. 9 illustrates a flowchart of operations performed by a vehicle software test environment management system to add a new machine image to a machine image catalog and select respective machine images from the machine image catalog to be implemented on vECUs in order to emulate ECUs of a real-world vehicle, according to some embodiments.

FIG. 10 illustrates a block diagram illustrating an example computer system that implements some or all of the techniques described herein, according to some embodiments.

While embodiments are described herein by way of example for several embodiments and illustrative drawings, those skilled in the art will recognize that embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (e.g., meaning having the potential to), rather than the mandatory sense (e.g., meaning must). Similarly, the words “include,” “including,” and “includes” mean including, but not limited to.

### DETAILED DESCRIPTION OF EMBODIMENTS

The systems and methods described herein include techniques for implementing a vehicle software test environment management system that provides instructions for implementing (or orchestrates the implementation of) a virtual vehicle environment comprising virtual electronic control units (vECUs), wherein the vECUs simulate electronic control units (ECUs) of a real-world vehicle. The vECUs may be configured according to a virtual bus connectivity configuration, wherein the virtual bus connectivity configuration simulates a bus and/or network configuration of the real-world vehicle. The vehicle software test environment management system may determine respective instance types to be used for one or more virtual compute instances that implement the vECUs based on respective configurations of the virtual compute instances, such as processor types, wherein the respective configurations are selected to approximate configurations of respective ones of the ECUs of the real-world vehicle. The vehicle software test environment management system may further select respective machine images to be used to emulate respective software environments of the ECUs. In some embodiments, the vehicle software test environment management system may deploy (or provide instructions to deploy or orchestrate the deployment of) a vehicle software application to be certified on the virtual vehicle environment and may perform (or provide instructions to perform) a test plan using recorded signals of the ECUs of the real-world vehicle, according to some embodiments.

In some embodiments, before a vehicle software application may be allowed to be deployed to a vehicle, the vehicle software may be required to undergo a testing and certification process. The testing and certification process may require that the vehicle software be deployed to one or more real-world vehicles, undergo various steps of a test plan, and may require resulting real-world vehicle signals to be analyzed to determine whether the signals fall within a threshold range as required by the test plan. For example, a testing and certification process for an automatic brake control software may involve deploying the automatic brake control software to a specific real-world vehicle (or a set of real-world vehicles), driving the vehicle towards an obstacle, and analyzing a force applied to a brake of the real-world vehicle and a velocity reading from a speedometer of the real-world vehicle. Based on the results of the testing on the real-world vehicle, the brake control software may be certified and allowed to be deployed on that real-world vehicle (or other vehicles that are deemed to be analogous to the real-world vehicle).

The testing and certification process on real-world vehicles may be slow and resource intensive. For example, testing of the automatic brake control software would require either actively driving a real-world vehicle to encounter test scenarios as called for in the test plan or may require passively driving the real-world vehicle until the real-world vehicle encounters the test scenarios. Furthermore, certification of vehicle software applications is often limited to specific real-world vehicle environments, and therefore such limitations may exacerbate the cost in both time and resources required to test and certify the vehicle software in physical vehicles. For example, a certification of the automatic brake control software in a first vehicle of a make “A” and a model “B” may be limited to that specific vehicle make/model. In order for the same automatic brake control software to be allowed to be deployed to another vehicle having make “C” and model “D”, the automatic brake control software may be required to be tested in the another make/model vehicle. Thus, depending on requirements for certification, there may be a need to individually test the vehicle software application on each of many different vehicle combinations. This may significantly increase costs associated with implementing a new software application and may further slowdown the implementation of the new software application. Although in some instances certification may also be applied to other vehicles that are deemed to be analogous, as a whole, the certification process in real-world vehicles may nevertheless require various types of physical vehicles to be used in testing and may be resource intensive.

In contrast, a virtual test vehicle environment may provide an alternative to testing performed on real-world vehicles. For example, a vehicle software application may be tested according to a test plan on a virtual test vehicle that functions as a replica of a real-world vehicle and the vehicle software application may be certified based on the testing on the virtual test vehicle in a virtual environment. However, certification of the vehicle software on a virtual test vehicle environment may require emulation of the various real-world vehicle components in a specific network configuration analogous to the real-world vehicle. For example, vehicles may be equipped with various electronic control units (ECUs) that use various types of processors and implement different vehicle software environments. In some embodiments, various ECUs of a real-world vehicle may be provided with processors implementing a variety of instruction set formats (ISAs), such as x86 or any other suitable ISAs. The various ECUs may also be provided with specialized processors such as graphics processing units (GPUs), application specific integrated circuits (ASICs), etc. Furthermore, respective software environments of the various ECUs may contain distinct respective software environments and may comprise various operating systems, deployed software, runtime environments, etc. For example, the software environments may implement various operating systems, including various types of real-time operating systems (RTOS). The software environments may also implement various deployed applications that perform various functions such as processing brake sensor signals or providing a gateway to send signals to a connected server, as a few examples. In order for a virtual test vehicle environment to accurately simulate a real-world vehicle environment and for a certification to be valid, the virtual test vehicle may be required to conform to performance criteria of the various ECUs of the real-world vehicle, including the software environments of the ECUs of the real-world vehicle and the network configurations of the ECUs of the real-world vehicle. As can be seen, providing such a real-world vehicle environment that simulates a real-world vehicle presents a non-trivial challenge.

In some embodiments, a vehicle software test environment management system may provide instructions for implementing (or orchestrates the implementation of) vECUs that simulate respective ones of the ECUs of a real-world vehicle. The vECUs may be configured according to a virtual bus connectivity configuration of a real-world vehicle. The vehicle software test environment management system may receive or access a vehicle graph indicating the ECUs of the real-world vehicle and their configuration. The vehicle software test environment management system may determine respective instance types of virtual compute instances to implement the vECUs based on processor types or other configurations of the ECUs, as indicated in the vehicle graph. For example, a first vECU may be a virtual compute instance having x86-based processors that simulates a first ECU similarly having a x86-based processor, whereas a second vECU may be a virtual compute instance having 64-bit Advanced RISC Machine (ARM) processors that simulates a second ECU similarly having 64-bit ARM processors. The vehicle software test environment management system may provision (or provide instructions to provision or orchestrate the provisioning of) the virtual compute instances and implement vECUs on the respective virtual compute instances. In some embodiments, the vehicle software test environment management system may provision (or provide instructions to provision or orchestrate the provisioning of) virtual compute instances having a different processor type and/or other specialized compute resource configurations, such as GPUs, wherein the different processor types and/or other specialized compute resource configurations correspond to configurations of a real-world vehicle. The vehicle software test environment management system may determine a virtual compute instance that best conforms to an ECU to simulate in order to reduce computing resource cost due to emulation. Furthermore, in some embodiments, the test environment management system may provide instructions for implementing (or orchestrate the implementation of) various machine images to emulate on a vECU that correspond to a respective software environment of the ECU. A machine image may provide information to implement, on the vECU, a software environment of an ECU, including configuration, metadata, permissions, and deployed software of the ECU. The machine image may furthermore provide an emulation layer to emulate the software environment of the ECU.

A vehicle software test environment management system may determine a virtual bus connectivity configuration for vECUs based on a connectivity configuration of ECUs indicated in a vehicle graph, such as vehicle deployment graph used for selecting deployment locations for software applications. For example, a vehicle may be arranged in a “zonal architecture” such that ECUs of a given zone are connected to one another through communications buses that are accessible only to the ECUs within the given zone. Sensor signals of a certain zone may be restricted to software applications deployed within the given zone. Also, the sensor signals of a given zone may not be accessible by software applications deployed outside of the given zone, such as at software applications deployed at another ECU connected to the ECU of the given zone via another bus-type, such as an ethernet bus. The vehicle software test environment management system may provide instructions for configuring (or orchestrate the configuration of) the vECUS in a virtual private cloud that implements a virtual bus connectivity configuration based on the connectivity configuration of the ECUs. In some embodiments, the software test environment management system may provide instructions for implementing (or orchestrate the implementation of) the virtual bus connectivity configuration by providing respective private network addresses to the vECUs, and configuring simulated vehicle bus interfaces for the respective vECUs to send and receive messages via the virtual private cloud, using the provided private network addresses, to simulate in-vehicle bus traffic.

Once the test environment has been generated, the vehicle software test environment management system may provide instructions for deploying (or orchestrate the deployment of) a vehicle software to be certified and perform a test plan using recorded signals of one or more ECUs of a real-world vehicle, according to some embodiments. The vehicle software test environment management system may send (or provide instructions for sending) the recorded signals of the one or more ECUs of the real-world vehicle to respective ones of vECUs of a virtual test vehicle environment via virtual hooks of the vECUs and perform testing according to a test plan. In some embodiments, the vehicle software test environment management system may determine (or receive a determination) that a response of the software application obtained from the test is within a threshold range as provided in the test plan. Based on the response, the vehicle software test environment management system may send a request that includes the response to a certification destination, and the certification destination may initiate its own separate internal certification workflow to determine whether the vehicle application should be certified and allowed to be deployed.

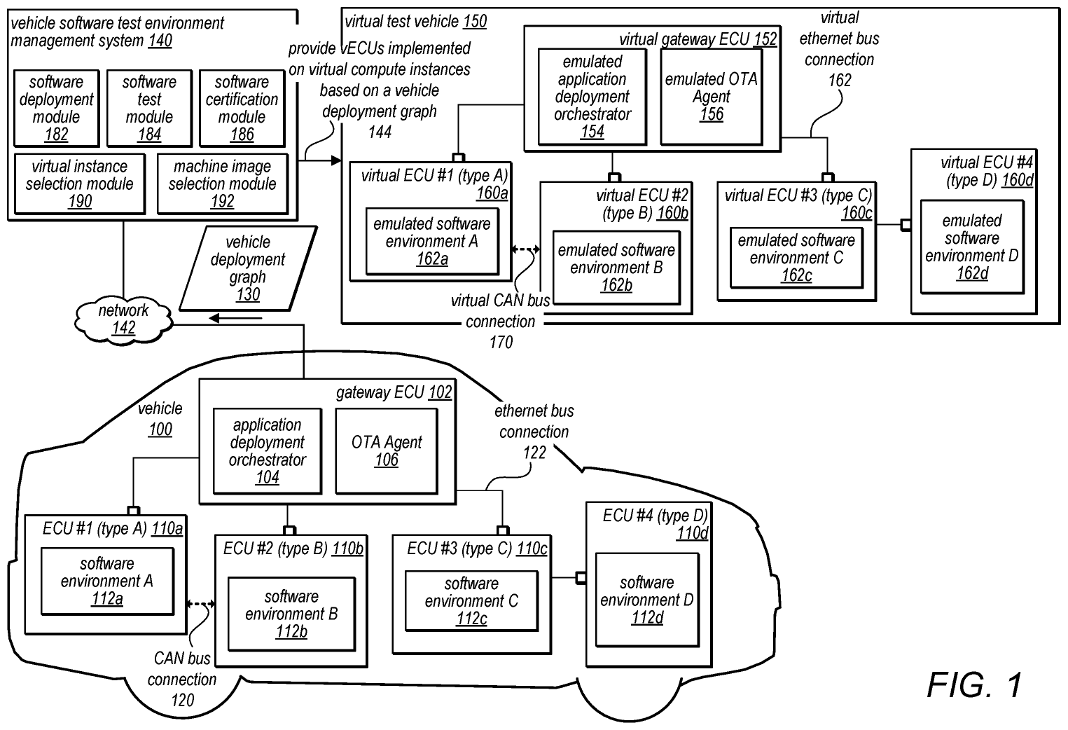

FIG. 1 illustrates a vehicle software test environment management system that receives a vehicle deployment graph indicating various electronic control units (ECUs) of a vehicle and indicating a network configuration of the vehicle, wherein the vehicle software test environment management system provides instructions for implementing (or orchestrates the implementation of) virtual electronic control units (vECUs) having a virtual bus connectivity configuration that simulates that of the vehicle, wherein the configured ECUs are used in performing software certification for one or more software applications to be deployed on the vehicle, according to some embodiments.

A vehicle 100 may include a vehicle system that includes various electronic control units (ECUs) #1-4 110a-110d that are of different types, wherein the ECUs #1-4 implement respective software environments A-D 112a-112d. The ECUs may use microprocessors or microcontrollers to control various functions of the vehicle. In some embodiments, the microprocessors may be small, low-power chips that may be specifically designed for embedded systems like an ECU. The various ECUs #1-4 110a-110d may include different types of ECUs having different ECU configurations, such as different processor types. For example, the type of microprocessor used in an ECU may depend on the specific application and requirements of the ECU. Some ECUs may use a single microprocessor to control multiple functions, while others may use multiple microprocessors to control various different specific functions. For example, as discussed above, different ECUs may contain different processors according to their type. In some embodiments, microprocessors used in ECUs may be based on architectures such as 64-bit Advanced Reduced Instruction Set Computer (RISC) Machine (ARM) architecture, PowerPC architecture, or x86 architecture. These architectures may provide a wide range of processing power and features, allowing manufacturers to choose the best option for their specific application. In addition to the microprocessors themselves, the ECUs #1-4 110a-110d may also use various other types of processors such as digital signal processors (DSPs) or field-programmable gate arrays (FPGAs) to handle specific functions like signal processing or data storage as well as use one or more graphics processing units (GPUs).

In some embodiments, each of the software environments A-D 112a-112d may be a software system that is designed to control and monitor various subsystems and components of the respective ECUs #1-4 110a-110d that it is implemented on. The software environments A-D 112a-112d may each be comprised of multiple software layers responsible for a specific function (or set of functions). For example, software environment A 112a may comprise multiple software layers including an Operating System (OS), middleware, and application software. In some embodiments, the software environments A-D 112a-112d may each comprise different software layers. For example, software environment A 112a may comprise a real-time operating system (RTOS) software that provides deterministic and predictable timing behavior for applications with real-time requirements whereas software environment C 112c may comprise a Linux operating system. The software environments A-D 112a-112d may furthermore comprise different middleware components for different network protocols (e.g., CAN, LIN), file systems, and I/O drivers for differing sensors and actuators. In some embodiments, the software environments A-D 112a-112d may include different applications to perform various functions. For example, the ECU #4 110d may be an engine control ECU and the software environment D 112d may comprise applications to control fuel injection, ignition timing, and/or other engine parameters.

In some embodiments, one or more of the respective ECUs #1-4 110a-110d (e.g., ECUs #1-3 110a-110c) may be connected to a gateway ECU 102 using an ethernet bus connection 122. The gateway ECU 102 may provide a central communication hub for various other ECUs #1-4 110a-110d in the vehicle 100 as well as provide a connection to a network 142. In some embodiments, the gateway ECU 102 may furthermore act as a gateway between different communication protocols used by different vehicle ECUs #1-4 110a-110d and enable them to exchange information with one another. For example, the gateway ECU 102 may receive data from the different ECUs #1-4 110a-110d and translates the data into a format that can be understood by the other subsystems, such as translating a signal formatted according to a CAN protocol into a format that can be understood by another ECU using LIN protocol. In some embodiment, the ECUs #1-4 110a-110d may be connected to one another using various communication buses. For example, the ECUs #1-3 110a-110c may be connected to the gateway ECU 102 via an ethernet bus connection 122, ECU #1 110a and ECU #2 110b may be connected to one another via a Controller Area Network (CAN) bus connection 120, and ECU #3 110c and ECU #4 110d may be connected to one another via an ethernet bus connection 122. The gateway ECU 102 may implement an application deployment orchestrator 104 and an over the air (OTA) agent 106. In some embodiments, the OTA agent 106 may receive, via the network 142, signed serialized data chunks of a vehicle software to be deployed at the vehicle along with a deployment plan. In some embodiments, the OTA agent 106 may verify that prerequisite vehicle software components, such as the images, are fully received and reconstructed before instructing the application deployment orchestrator 104 to process the deployment plan. The deployment orchestrator 104 may process the deployment plan and send one or more deployment instructions to relevant ones of the ECUs #1-4 110a-110d to deploy the software application, in some embodiments. The one or more deployment instructions may be one or more execution plans for implementing the vehicle software application at the vehicle based on the received deployment plan. Although FIG. 1 depicts the vehicle system of the vehicle 100 with the gateway ECU 102 and the ECUs #1-4 110a-110d connected to one another via the ethernet bus connection 122 and the CAN bus connection 120, this illustration is intended only as an example and it should be understood that a vehicle system may have various number/types of ECUs and various configurations.

In some embodiments, the gateway ECU 102 may send a vehicle deployment graph 130 of the vehicle 100 to a vehicle software test environment management system 140. A vehicle deployment graph may be a graphical representation of the various ECUs and communication network within the vehicle 100. In some embodiments, the vehicle deployment graph 130 may represent the ECUs #1-4 110a-110d and the network connections (e.g., the CAN bus connection 120 between ECU #1 110a and ECU #2 110b) as nodes on the graph, wherein the nodes represent the ECUs #1-4 110a-110d of the vehicle 100, and the edges represent the communication bus links between the ECUs #1-4 110a-110d. The vehicle deployment graph 130 may indicate a configuration of the ECUs #1-4 110a-110d and their types (e.g., processor types), indicate information regarding respective software environments A-D 112a-112d (e.g., the type of operating system, deployed applications), and indicate connectivity configuration of the ECUs of the vehicle 100. In some embodiments, the vehicle deployment graph 130 of the vehicle 100 may be received or accessed by the vehicle software test environment management system 140 from a vehicle deployment graph repository instead of directly receiving the vehicle deployment graph 130 from the gateway ECU 102 of the vehicle 100. In some embodiments, the vehicle deployment graph may also be obtained from a vehicle original equipment manufacturer (OEM) or other part supplier and/or may be maintained and updated by the vehicle software test environment management system 140 (or may be maintained and updated by a vehicle software deployment system (not shown in FIG. 1)).

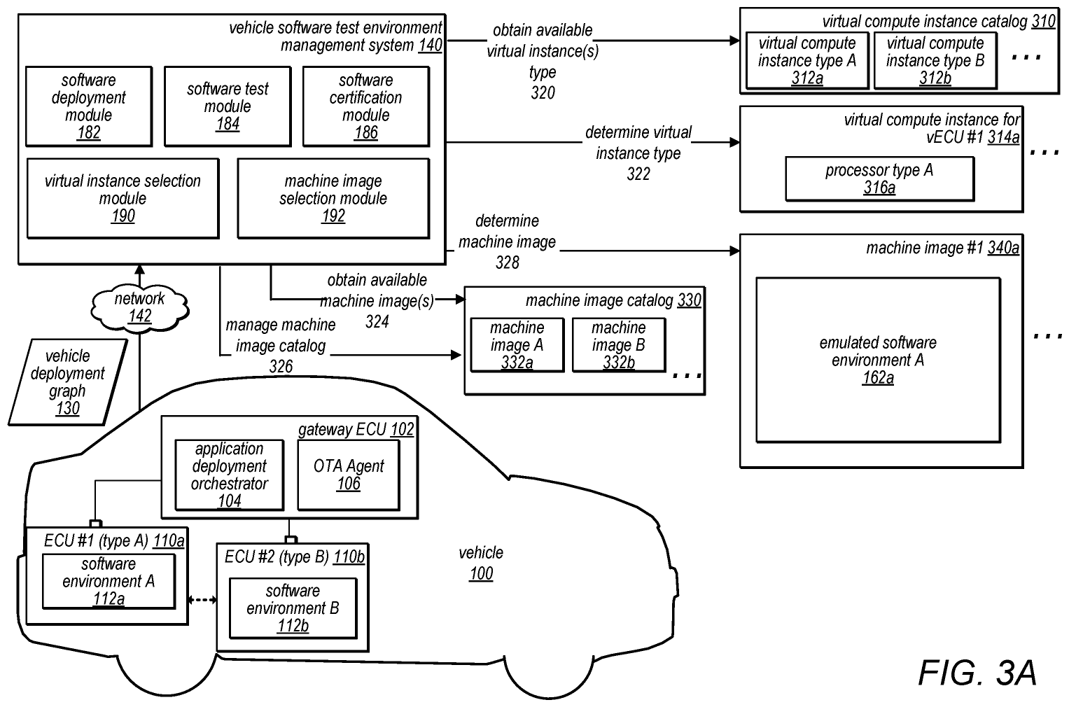

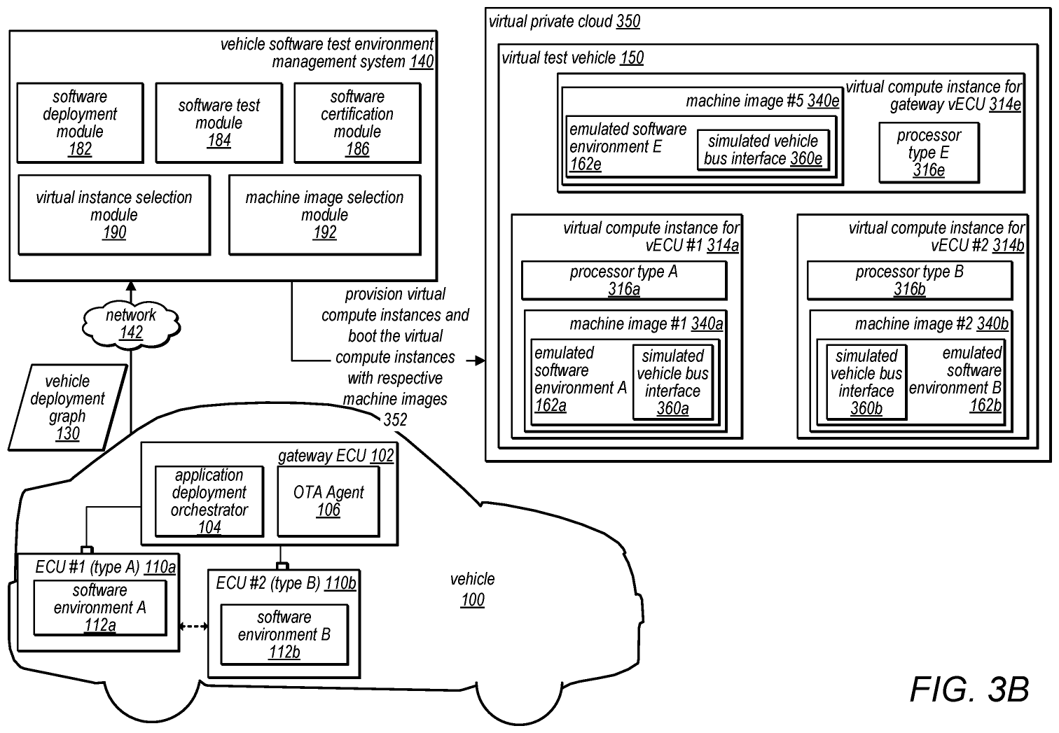

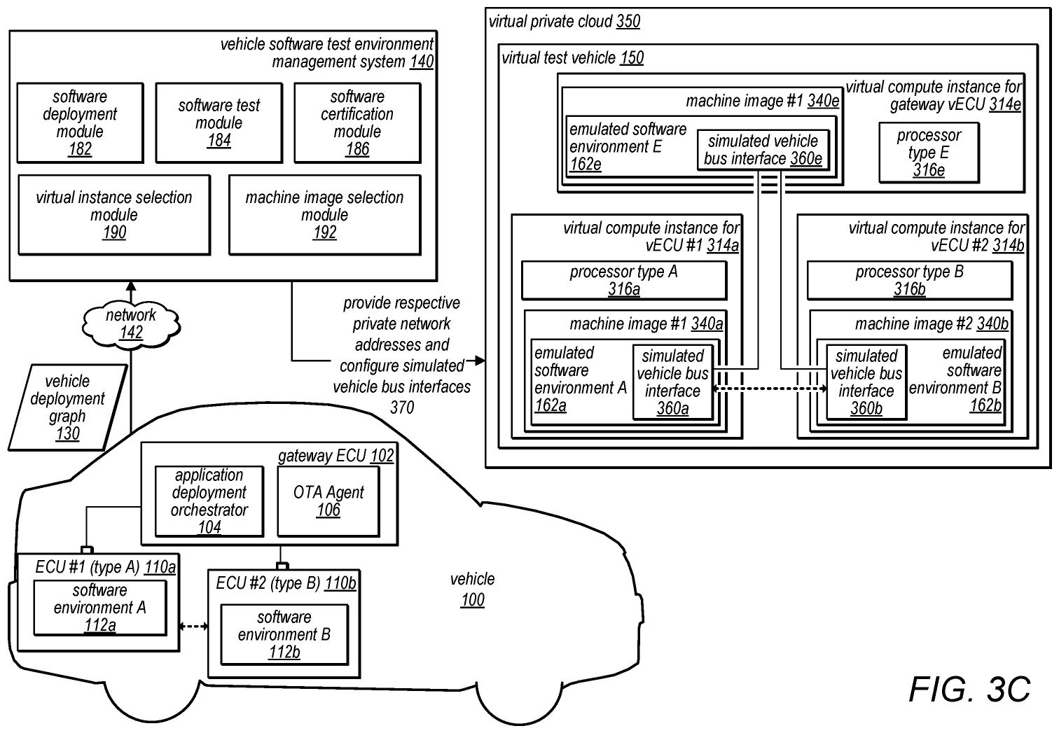

In some embodiments, the vehicle software test environment management system 140 may include a software deployment module 182, a software test module 184, a software certification module 186, a virtual instance selection module 190, and a machine image selection module 192. The vehicle software test environment management system 140 may provide instructions for implementing (or orchestrates the implementation of) a virtual test vehicle comprising virtual vECUs, wherein the vECUs simulate ECUs of a real-world vehicle. For example, the vehicle software test environment management system 140 may provide instructions for implementing a virtual test vehicle 150 including virtual vECUs #1-4 160a-160d, and a virtual gateway ECU 152 that simulate respective ones of the ECUs #1-4 110a-110d and the gateway ECU 102 of the vehicle 100. The virtual vECUs #1-4 160a-160d may implement emulated software environments A-D 162a-162d that emulate the software environments A-D 112a-112d. The emulation of the software environments will further be discussed in FIG. 3B. The virtual instance selection module 190 may provide instructions to provision the vECUs #1-4 160a-160d and the virtual gateway ECU 152 on respective virtual compute instances. The machine image selection module 192 may provide instructions to implement machine images to further implement emulated software environments of the various vECUs of the virtual test vehicle 150 (e.g., emulated software environments A-D 162a-162d, emulated application deployment orchestrator 154, and emulated OTA agent 156) on respective ones of the virtual compute instances that the vECUs are implemented on. The virtual instance module 190 and the machine image module 192 will be further discussed in FIGS. 3A-3C.

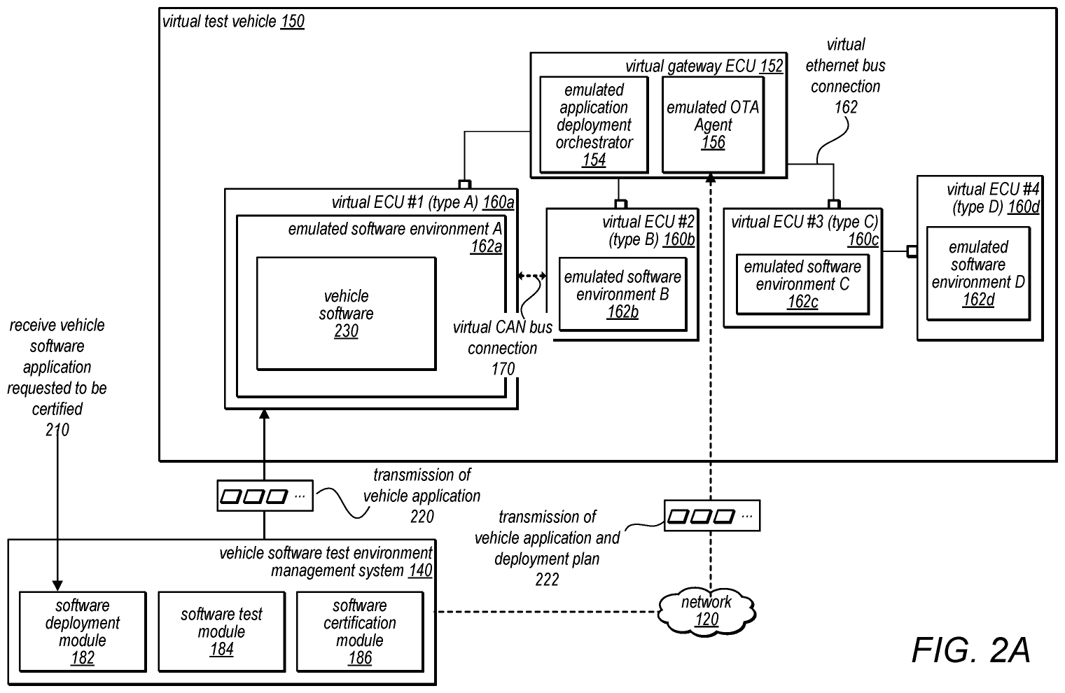

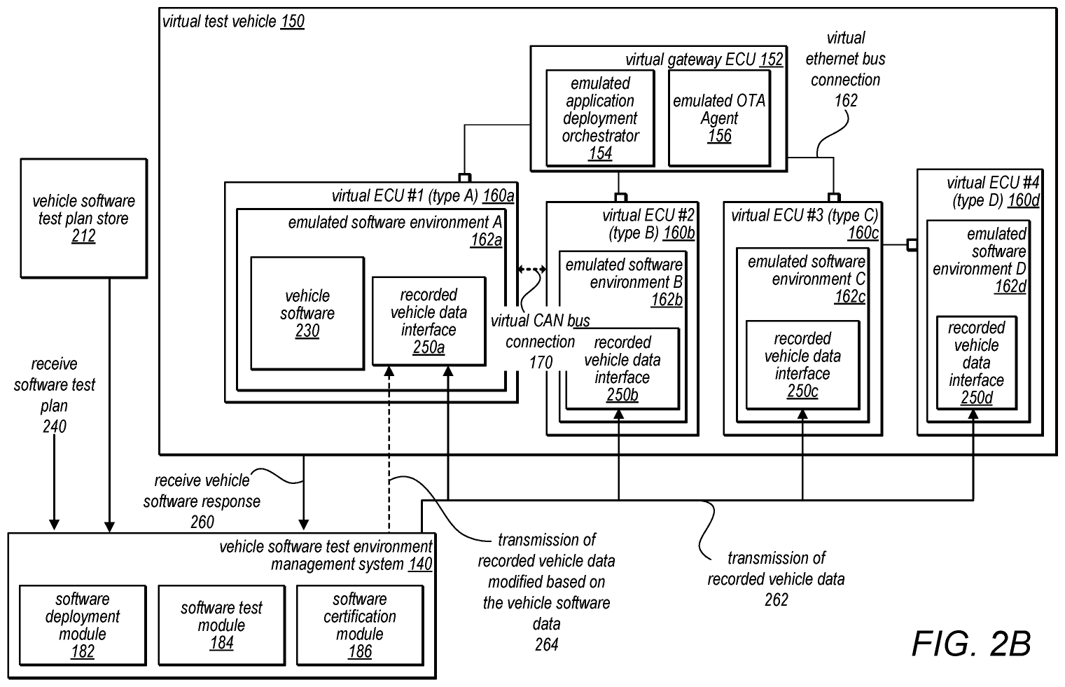

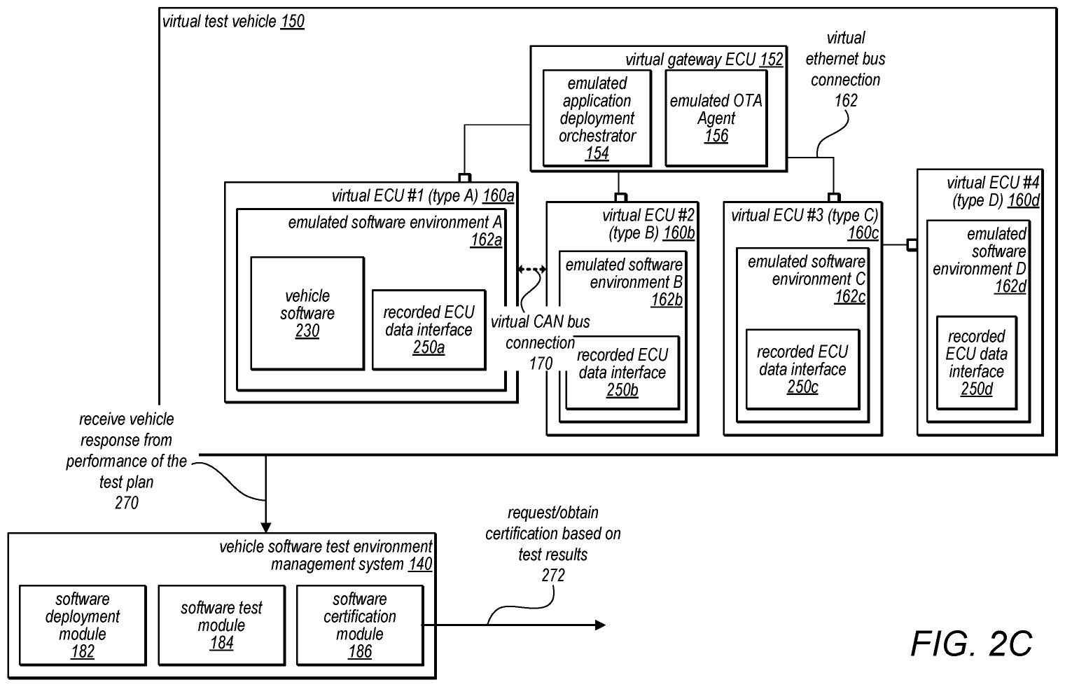

In some embodiments, the vehicle software test environment management system 140 may provide instructions to certify (or instructions to obtain certification of) a vehicle software application. For example, the software certification module 186 may receive a vehicle software application with a request to certify the vehicle software application. The certification request for the vehicle software application may, in some embodiments, include a deployment plan and/or a test plan. In some embodiments, the software deployment module 182 may deploy (or provide instructions to deploy) the vehicle software application requested to be certified to one or more of the vECUs #1-4 160a-160d via the virtual gateway ECU 152. The software deployment module 182 and deployment of the vehicle software application will be further discussed in FIG. 2A. In some embodiments, the software test module 184 may send (or provide instructions for sending) recorded signals of the one or more sensor inputs to the ECUs #1-4 110a-110d of the vehicle 100 to respective ones of vECUs #1-4 160a-160d of a virtual test vehicle to perform the test plan. The software test module 184 and testing of the vehicle software will be further discussed in FIG. 2B. In some embodiments, the software certification module may obtain a response data for the software application and request/obtain certification of the vehicle software based on the response data. The software certification module 186 and certification of the vehicle software will be further discussed in FIG. 2C.

FIG. 2A illustrates a graphical view of a vehicle software test environment management system, its various parts, and interactions to deploy a vehicle software application, for which certification is being performed, to vECUs of a virtual test vehicle having vECUs configured according to a virtual bus connectivity configuration, according to some embodiments.

In some embodiments, the software deployment module 182 may receive a vehicle software application requested to be certified 210. In some embodiments, the software deployment module 182 may receive a request sent by a deployment plan generator that generates multiple deployment plans for various vehicle models, wherein the deployment plan generator sends the certification requests as part of the deployment planning process. The deployment plan generator may request the vehicle software test environment management system 140 for the vehicle software be certified in virtual replicas of the various vehicle models.

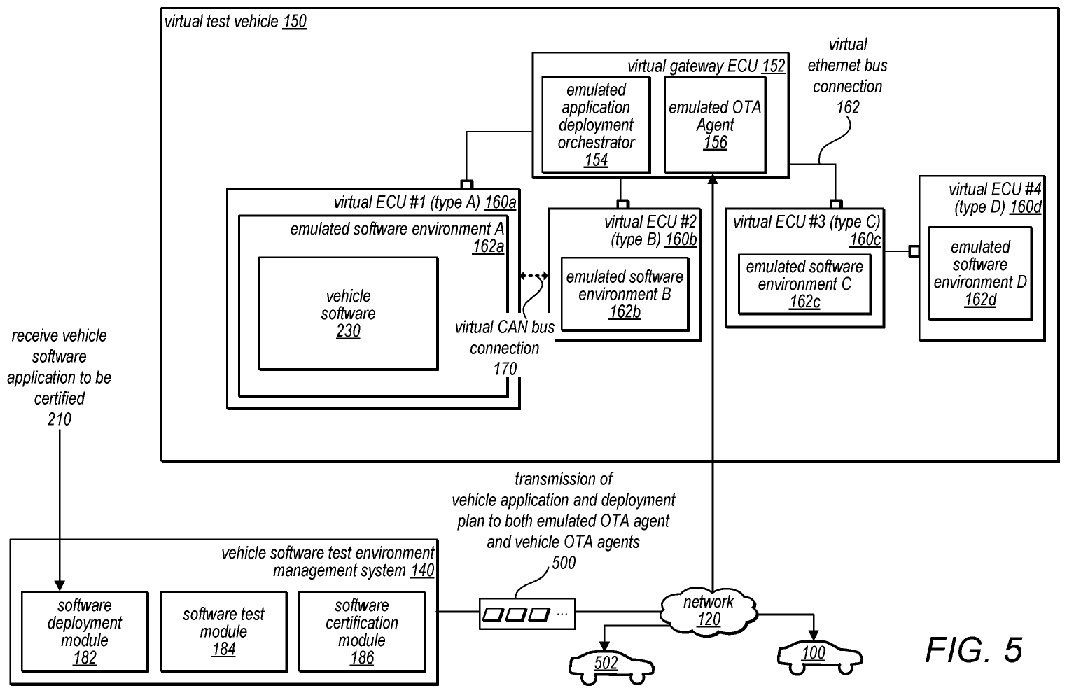

Moreover, upon receiving a request for certification of the vehicle software, in some embodiments, the software deployment module 182 may provide instructions to perform transmission of the vehicle application and deployment plan 222 to the emulated OTA agent of the virtual test vehicle 150 via the network 120. The emulated OTA agent 156 may simulate the deployment processes of the OTA agent 106 of the gateway ECU 102. For example, the emulated OTA agent 156 may generate a chunked version of the vehicle software and deployment plan to be sent to the vehicle via an external data transmission service (such as a third-party OTA service). In some embodiments, additional signing/encryption may be used by the external service used to transmit the data chunks. In some embodiments, the chunked vehicle software and deployment plan to the vehicle may be in a protocol agnostic transmission format that is compatible with various external data transmission service/OTA services utilizing a plurality of different transmission protocols. In some embodiments, the emulated OTA agent 156 may verify that prerequisite vehicle software components, such as the software packages, are fully received and reconstructed and instruct the emulated application deployment orchestrator 154 to process the deployment plan. The emulated application deployment planner 154 may incrementally reconstruct the deployment plan and application packages/container images to be used to implement the vehicle software. Similar to that of the application deployment orchestrator 104, the emulated application deployment orchestrator 154 may process the received deployment plan and send one or more deployment instructions to relevant ones of the vECUs #1-4 160a-160d to deploy a software application 230 to the emulated software environment A 162a. In some embodiments, the external data transmission service/OTA services may furthermore be compatible with real-world vehicles as further discussed in FIG. 5. In some embodiments, instead of (or in addition to) the transmission of a vehicle application and deployment plan 222 to the emulated OTA agent 156, the vehicle software test environment management system 140 may send or (request to send) the vehicle software to the virtual ECU #1 160a directly. The virtual ECU #1 160 may be equipped with a software hook to receive transmission of the vehicle application 230 directly.

FIG. 2B illustrates a graphical view of a vehicle software test environment management system, its various parts, and interactions that conduct performance of a test plan for a vehicle software application on vECUs of a virtual test vehicle having vECUs configured according to a virtual bus connectivity configuration, according to some embodiments.

In some embodiments, the vehicle software test environment management system 140 may receive a software test plan 240. The test plan may be associated with the vehicle software that has been requested to be certified. In some embodiments, the test plan may detail one or more requirements and parameters for testing the vehicle software. In some embodiments, a test plan may be a detailed document that catalogs the test strategy, objectives, and/or the resources required in testing the vehicle software as part of a certification process and may indicate a threshold range of resulting responses of the vehicle software to pass the certification test. In some embodiments, the testing procedures described in various test plans may be different depending on the vehicle model indicated for the vehicle software. In some embodiments, a single test plan may contain multiple procedures that describe various different procedures for multiple vehicle models. In some embodiments, the vehicle software test environment management system 140 may access, from a vehicle software test plan store 212, a test plan that is associated with the requested vehicle software. A vehicle software test plan store 212 may be a centralized repository that contains test plans and may provide a standardized and structured approach to testing vehicle software across different vehicle models. In some embodiments, the test plan may furthermore be selected based on the vehicle model that the vehicle software is requested to be certified on from a vehicle software test plan store 212.

In some embodiments, the vehicle software test environment management system 140 may configure (or provide instructions to configure) the virtual test vehicle 150 to conform to the testing environment described in the test plan by simulating data that would be generated in a real-world vehicle in the test situation. The vehicle software test environment management system 140 may send recorded vehicle data 262 that simulates the data from recorded ones of the test plan scenarios. For example, a real-world vehicle may record signal data of one or more ECUs as it undergoes certain test situations as described in the test plan. The software environments A-D 162a-162d of the vECUs #1-4 160a-160d may respectively comprise recorded vehicle data interfaces 250a-250d that respectively provide a virtual hook for the recorded ECU signal data received by the respective virtual ECUs #1-4 160a-160d. In some embodiments, the vehicle software test environment management system 140 may apply only a portion of the received recorded signals corresponding to a first set of moments in time to the respective ones of the one or more of the vECUs #1-4 160a-160d via the virtual hooks.

In some embodiments, vehicle software test environment management system 140 may modify a second portion of the recorded signals corresponding to a second set of moments in time based on the received sensor outputs from the vECUs, and apply the modified second portion of the recorded signals to the respective ones of the one or more of the vECUs via the virtual hooks for the second set of moments in time. For example, upon the respective vECUs #1-4 160a-160d receiving the recorded ECU signal data, the vehicle software 230 may generate a response. The vehicle software test environment management system 140 may receive a vehicle software response 260 as part of the performance of the test plan described above. Based on the received response, the vehicle software test environment management system 140 may modify the recorded vehicle data to account for the impact of the vehicle software 230, as indicated in the response, to update the recorded data to account for the impact of the software being tested. The vehicle software test environment management system 140 may transmit the recorded vehicle data that has been modified based on the vehicle software data 264 instead of the unmodified recorded data. For example, based on the received vehicle software response 260 of an automatic brake system deployed in the virtual ECU #1 160a, the vehicle software test environment management system 140 may modify recorded velocity data to be modified to account for deceleration at an earlier time due to the automatic brake system initiating the brakes at the earlier time. The modified vehicle data may then be transmitted back as modified ECU signal data and be received by the respective virtual ECUs #1-4 160a-160d.

In some embodiments, the response of the software application during the performance of the test plan may be non-deterministic. The vehicle software test environment management system 140 may perform the test plan multiple times in order to obtain a range of performance levels for the vehicle software application upon indication that the response of the software application during the performance of the test plan is non-deterministic. The vehicle software test environment management system 140 may determine whether a threshold range for certification for the non-deterministic software application has been met based on the range of performance levels.

FIG. 2C illustrates a graphical view of a vehicle software test environment management system, its various parts, and interactions to provide results of performance of a test plan and requesting/obtaining certification based on the received results, according to some embodiments.

In some embodiments, the vehicle software test environment management system 140 may receive vehicle software response from performance of the test plan 270. The received vehicle response from performance of the test plan 270 may be, in some embodiments, a vehicle response that was subsequently generated based on transmission of the modified vehicle software data 264 (as discussed above in FIG. 2B). In some embodiments, subsequent to receiving the vehicle software response from performance of the test plan 270, the vehicle software test environment management system 140 may request and/or obtain certification based on the test results 272 of the test plan, as discussed above in FIGS. 2A-2B. In some embodiments, the deployment plan generator 104 may request certification of the vehicle software 230 by sending a request for certification to a certification destination, wherein the request may comprise one or more of: the deployment plans used to be used to deploy the vehicle software 230, the vehicle software 230 itself, vehicle software dependencies, vehicle metadata, and/or results of the test plan. The certification destination may initiate its own separate internal certification workflow to determine whether the deployment plan should be certified and allowed to be used to deploy the software application or multiple software applications. In some embodiments, the certification destination may reject the certification request. In other embodiments, the certification destination may approve the certification request and send an indication of approval of certification to the vehicle software test environment management system 140. In some embodiments, the environment management system 140 may initiate its own certification workflow to determine whether the deployment plan should be certified and allowed.

FIG. 3A illustrates a more detailed view of a vehicle software test environment management system that obtains available virtual instance types and machine images and determines a virtual instance type and a machine image needed to be used to simulate respective ECUs of the vehicle using respective vECUs, according to some embodiments.

In some embodiments, the vehicle software test environment management system 140 may obtain information about available virtual instance type(s) 320 from a virtual compute instance catalog 310. The virtual compute instance catalog 310 may comprise one or more virtual compute instance types (e.g., virtual instance type A 312a and virtual instance type B 312b) that may be available to be provisioned to implement a vECU. For example, the virtual compute instance type may be a specific type of a virtual machine that runs on a cloud computing infrastructure with a specific physical computer system and provides a certain configuration of computing resources such as CPU, memory, storage, and network connectivity. For example, the virtual compute instance type A 312a may be a virtual machine that runs on a physical computer system having four 64-bit ARM processors. In some embodiments, the virtual compute instance types may indicate an instance type that runs on top of a host operating system and that shares physical resources with other virtual machines. In some embodiments, the compute instance type may be a bare metal compute instance that runs directly on a physical hardware, without the need for a hypervisor or operating system to be installed (e.g., a non-virtualized computing instance). As discussed above, the compute instances type may include various compute instances configurations including having various processor types or other compute resource configurations including various numbers of CPUs, amounts of memory, and types and/or sizes of storage.

In some embodiments, the vehicle software test environment management system 140 may determine (or receive a determination of) a virtual instance type 322 to be used to implement respective virtual compute instances for the vECUs #1-4 160a-160d. For example, based on the deployment graph indicating that ECU #1 110a has a type “A” ECU configuration, the vehicle software test environment management system 140 may determine that a virtual compute instance for vECU #1 314a (that is to be used to simulate ECU #1 110a) is to be equipped with a processor type A 316a. In some embodiments, the vehicle software test environment management system 140 may receive instructions to determine a virtual instance type B 312b to implement vECU #2 314b. In some embodiments, the determination of a virtual instance type may be based on an emulation cost as further discussed in FIG. 3B.

In some embodiments the vehicle software test environment management system 140 may furthermore obtain information regarding available machine image(s) 324 from a machine image catalog 330. The machine image catalog 330 may comprise various machine images (e.g., machine image A 332a, machine image B 332b). In some embodiments, a machine image may be a snapshot of a virtual machine or server at a specific point in time, which can be used to create new instances that are identical (or mostly identical) to the original instance with a certain configuration implemented, such as a certain vECU configuration. The machine image may comprise an image of an operating system, software applications, data, and other necessary components needed to run a specific workload or application of an ECU. For example, the machine image A 332a may be an image of the software environment A 112a, and may be a snapshot that represents a state and/or configuration of ECU #1 110a at a specific moment in time. In some embodiments, the machine image A 332a may be used to launch a virtual compute instance with all the same (or similar) configurations, software, and data as the software environment A 112a. Similar to the determination of virtual instance types, in some embodiments, the vehicle software test environment management system 140 may determine (or receive a determination of) a machine image 328 to implement respective software environments for the vECUs #1-4 160a-160d. For example, based on the deployment graph indicating that software environment A 112a has a Linux operating system (and/or other software environment configuration, such as the type of middleware or applications installed), the vehicle software test environment management system 140 may determine that a machine image #1 340a having emulated software environment A 162a is to be implemented on the virtual compute instance for vECU #1 314a. In some embodiments, the vehicle software test environment management system 140 may receive instructions to determine a machine image #2 to be implemented in the virtual compute instance for vECU #2 314b. In some embodiments, the vehicle software test environment management system 140 may first determine a machine image for a vECU and then determine a virtual compute instance type to use for the vECU based on a determined machine image. For example, the vehicle software test environment management system 140 may determine that a machine image A 332a is to be used for vECU #1 to simulate ECU #1, and subsequently determine that a virtual compute instance type A 312a is to be used based on metadata associated with the machine image A 332, wherein the metadata indicates that the virtual compute instance type A 312a is to be used to implement the machine image A 332, as an example. In some embodiments, the vehicle software test environment management system 140 may determine which virtual compute instance types are to be used based on an analysis of emulation costs to run the machine images on the respective types of the virtual compute instances.

The vehicle software test environment management system 140 may furthermore manage a machine image catalog. In some embodiments, the vehicle software test environment management system 140 may add a machine image, modify an existing machine image, or remove a machine image from the machine image catalog 330. For example, the vehicle software test environment management system 140 may receive an ECU information for another ECU from a vehicle manufacturer or a vehicle parts manufacturer, and based on the received ECU information create a new machine image that simulates the software environment of the ECU. Upon a request to create a new machine image (or receipt of the new machine image from the vehicle manufacturer or the vehicle parts manufacturer), the vehicle software test environment management system 140 may add the new machine image to the machine image catalog 330.

FIG. 3B illustrates a more detailed view of a vehicle software test environment management system that provisions virtual instances having respective virtual instance types and machine images selected to simulate ECUs of a vehicle based on a vehicle deployment graph, according to some embodiments.

The vehicle software test environment management system 140 may provision (or provide instructions to provision) the virtual compute instances that were determined (as shown in FIG. 3A) in a virtual private cloud. For example, the vehicle software test environment management system 140 may provision virtual compute instances and boot the virtual compute instances with respective machine images 352 on the virtual private cloud 350. A virtual private cloud 350 may allow the virtual test vehicle 150 and the various virtual compute instances 314a-314e to be isolated from other networks, including the internet and may provide a secure and isolated environment. The vehicle software test environment management system 140 may provision (or provide instructions to provision) the virtual compute instances 314a-314e having various processor types A-E 316a-316e by allocating a portion of their underlying physical resources, such as CPU, memory, and storage, to create a virtualized environment where virtual compute instances can be provisioned. Additionally, the software test environment management system 140 may provision (or provide instructions to provision) the virtual compute instances to boot up using the respective machine images (e.g., machine image #1-5 316a-316c) determined for the respective virtual instances as discussed in FIG. 3A.

In some embodiments, the emulated software environments A-E 162a-162e may emulate a matching software environment by respectively providing an abstraction layer that may allow the vehicle software to be run on different hardware platforms without requiring modification. For example, an emulator of the emulated software environment A 162a, may run on the virtual compute instance for vECU #1 314a and translate the vehicle software's instructions into the native instruction set of the vECU #1 314a. In some embodiments, the translation of instruction may allow the software to be executed on the vECU #1 314a, as if it were running natively on a target platform of a real-world ECU corresponding to the vECU #1 314a. In some embodiments, because emulation involves additional processing overhead compared to running software natively on the target platform, performance may be slower. The vehicle software test environment management system 140 may determine to utilize certain ones of the virtual compute instance type to decrease the performance loss due to emulation. In some embodiments, the vehicle software test environment management system 140 may furthermore implement emulated software environments that use just-in-time (JIT) compilation techniques to dynamically translate instructions into the native instruction set of the target platform. The emulated software environments A-E 162a-162e may furthermore comprise simulated vehicle bus interfaces 360a-360c that may be used to simulate the network connectivity of the ECU in a vECU environment.

FIG. 3C illustrates a more detailed view of a vehicle software test environment management system that configures simulated vehicle bus interfaces of virtual instances having respective virtual instance types and machine images selected to simulate the ECUs of the vehicle in a network configuration of the vehicle according to a vehicle deployment graph, according to some embodiments.

In some embodiments, the vehicle software test environment management system 140 may configure routing tables and control IP address ranges, security groups, and network access policies using simulated vehicle bus interfaces 360a-360c to replicate the network connectivity configuration of a real-world vehicle. In some embodiments, the virtual private cloud 350 may be customized with an IP address range, subnets, and routing tables and may represent a virtual environment that simulates an in-vehicle communication of the vehicle 100 (or a subset of ECUs of the vehicle). As discussed above in FIG. 3B, the various virtual compute instances 314a-314c may be isolated from other networks using the virtual private cloud 350. For example, the vehicle software test environment management system 140 may configure the simulated vehicle bus interfaces 360a-360c to simulate in-vehicle traffic by controlling the routing tables to be allowed to communicate with the vECUs according to the vehicle deployment graph 130. ECU signals as discussed above in FIG. 1 may use various bus protocols include CAN (Controller Area Network), LIN (Local Interconnect Network), and FlexRay. In order to simulate in-vehicle communication of the vehicle in a virtual test vehicle 150, the simulated vehicle bus interfaces 360a-360c may translate one type of protocol to another to be sent over the virtual private cloud 350 as translated signals received from one type of protocol to another. For example, the simulated vehicle bus interfaces 360a may be configured to be connected to virtual compute instance for gateway vECU 314e using an ethernet protocol and connected to the virtual compute instance for vECU #2 314b using a CAN bus protocol. The simulated vehicle bus interface 360a may translate a CAN bus protocol formatted signal to be sent to the virtual compute instance for vECU #2 314b into an ethernet protocol to enable transmission over the virtual private cloud 350 (or other network, such as the Internet, that the virtual compute instances are connected on). A simulated vehicle bus interface 360b may receive the translated message back into the CAN bus protocol formatted signal to simulate the in-vehicle traffic of the vehicle 100. As discussed in FIG. 1, the virtual bus connectivity configuration of the vECUs may be based on the vehicle deployment graph 130. Thus, the virtual bus connectivity configuration in the virtual private cloud may emulate the network environment of the real-world vehicle for which a virtual test vehicle is being implemented in the virtual private cloud.

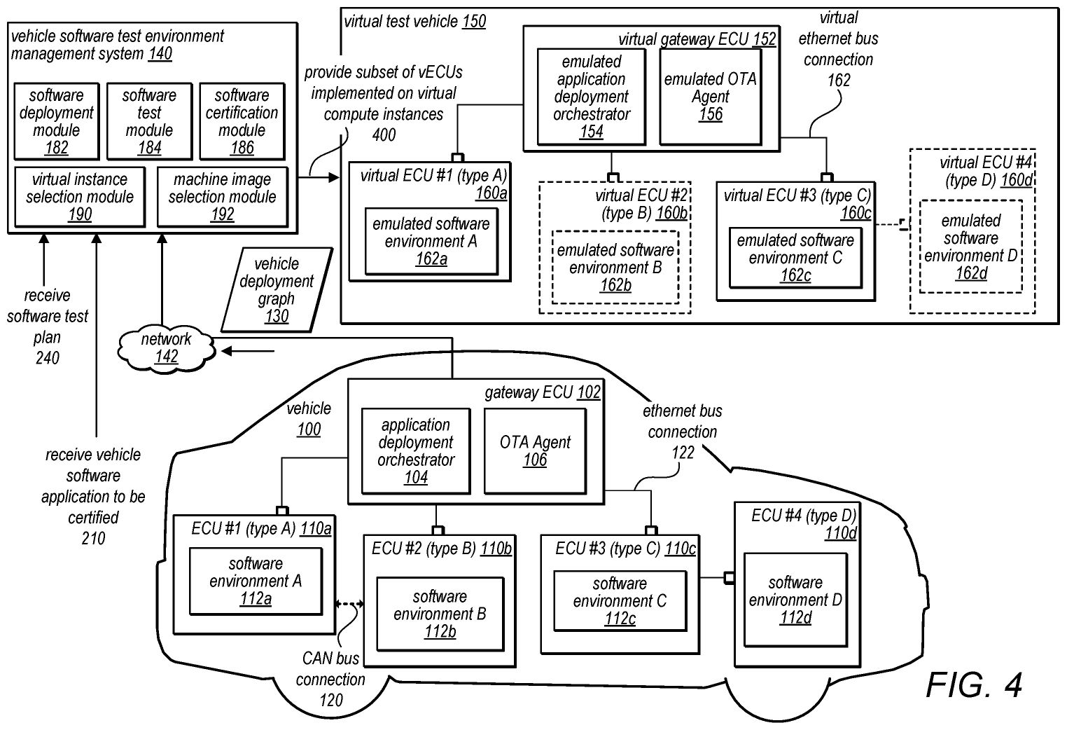

FIG. 4 illustrates a more detailed view of a vehicle software test environment management system that provides vECUs implemented on virtual compute instances to simulate a subset of the ECUs of the vehicle for a partial simulation, according to some embodiments.

In some embodiments, simulating all ECUs in a vehicle, via vECUs, may not be necessary or practical. For example, in a vehicle with dozens of ECUs, the hardware resources required to simulate all of the ECUs may be prohibitive or unnecessarily complex to manage relative to a certification task to be performed. Additionally, in some cases, only certain ECUs may be involved in the development or testing of a vehicle software and may be unnecessary to simulate all of them. In some embodiments, the virtual test vehicle 150 may simulate only a subset of the set of ECUs. To simulate a subset of ECUs, the vehicle software test environment management system 140 may identify which ECUs are to be added to the virtual test vehicle 150 to test the vehicle software. In some embodiments, the vehicle software test environment management system 140 may include only ECUs that are critical to the performance of the vehicle software. For example, the vehicle software test environment management system 140 may receive an automatic braking software as the vehicle software application to be certified 210. The vehicle software test environment management system 140 may furthermore receive a software test plan 240 for the automatic braking software. Based on the received vehicle software and/or based on the test plan received, the vehicle software test environment management system 140 may determine that ECU #2 110b and ECU #4 110d that are directed towards a climate control system and an infotainment system and are to be excluded in the virtual test vehicle 150. Once the relevant ECUs have been identified, the vehicle software test environment management system 140 may selectively provision (or provide instructions to provision) the vECUs that correspond to a relevant subset of a larger set of the ECUs of the given vehicle as communicated in the vehicle deployment graph 130.

FIG. 5 illustrates a more detailed view of a vehicle software test environment management system that deploys a vehicle software application to be certified to a virtual test vehicle using an emulated over-the-air (OTA) agent of the virtual test vehicle, according to some embodiments.

In some embodiments, the vehicle software test environment management system 140 may receive the vehicle software application to be certified 210 and deploy (or provide instructions to deploy) the vehicle software application to a virtual test vehicle using an emulated over-the-air (OTA) agent of the virtual test vehicle. In some embodiments, the vehicle software 230 application may be deployed to both the virtual test vehicle 150 via the emulated OTA agent 156 and also to real-world vehicles, such as vehicle 100 and vehicle 502. The vehicle software test environment management system 140 may provide instructions for transmission of vehicle application deployment plan to both emulated OTA agent and vehicle OTA agents 500, in some embodiments. For example, the vehicle application may be packaged into a format that can be sent to both the OTA agent in the ECU and the emulated OTA agent in the virtualized ECU. This could be a binary file, a compressed archive, or some other suitable format. In some embodiments, communication channels may need to be established between the sender (e.g., vehicle software test environment management system 140) and the two receivers (e.g., the OTA agent 106 in the gateway ECU 102 and the emulated OTA agent 156 in the virtualized ECU 152). The vehicle software test environment management system 140 may set up network connections, establish security protocols, and ensure that the sender has the necessary access privileges to communicate with both agents. Once the communication channels to the respective agents are established, the vehicle application may be sent to both the OTA agent 106 in the gateway ECU 102 and the emulated OTA agent 156 in the virtualized ECU 152. In some embodiments, the transmission may involve sending the vehicle software as a single package or breaking it up into smaller pieces to optimize transmission and ensure reliability. This process may ensure that any losses or degradations in transmission of a vehicle software package to a vehicle using an OTA agent are also accounted for in the testing via the virtual vehicle.

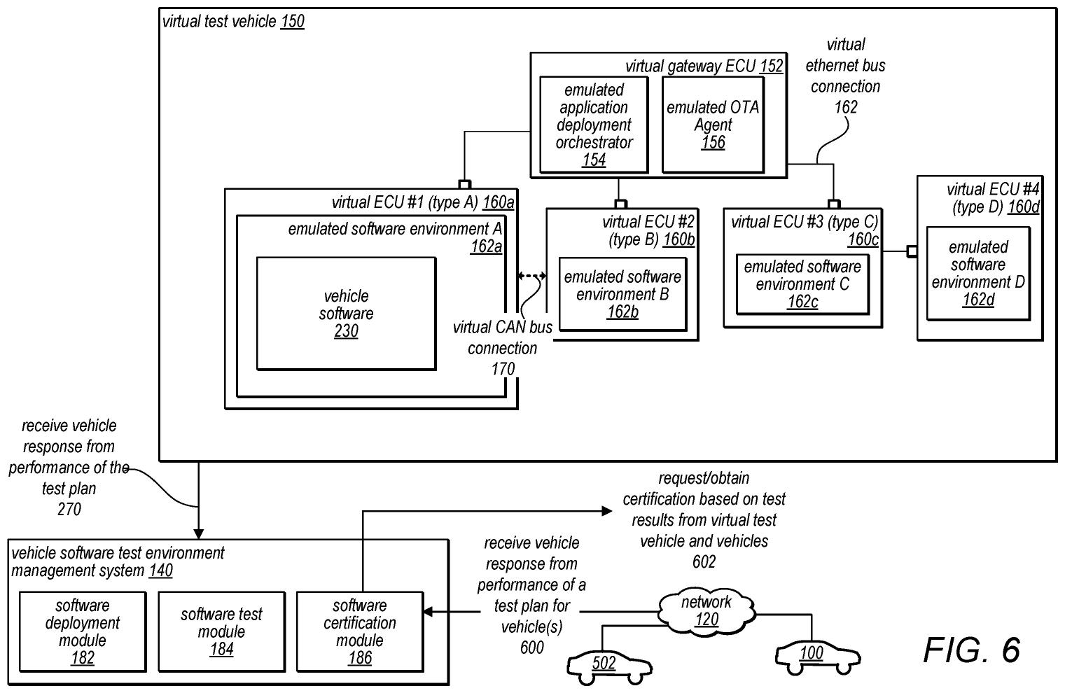

FIG. 6 illustrates a more detailed view of a vehicle software test environment management system that requests/obtains certification of a vehicle software application based on test results from a virtual test vehicle and/or results from testing performed using one or more real-world vehicles, according to some embodiments.

In some embodiments, the vehicle software test environment management system 140 may determine that it is necessary to test a software application on both virtual and real ECUs. For example, the vehicle software test environment management system 140 may determine that although testing on virtual ECUs is more cost-effective and eliminates the need for physical hardware, it may determine that testing on real-world ECUs is also necessary to test the vehicle software's compatibility with the specific hardware and operating conditions of the vehicle 100. In some embodiments, the real-world testing can identify issues related to the physical hardware, such as communication issues or hardware failures. In some embodiments, virtual testing may supplement real-world testing. For example, a limited number of real-world tests may be performed to identify issues that cannot be replicated in the virtual testing, and a larger number of test runs may be performed using the virtual vehicle in order to explore software responses for conditions that can be replicated reasonably well in the virtual environment. In some embodiments, the vehicle software test environment management system 140 may perform tests on real-world vehicles 100 and 502 as well as on the virtual test vehicle 150. The vehicle software test environment management system 140 may receive vehicle responses from performance of the test plan 270 from the virtual test vehicle 150 (as discussed in FIG. 2C) as well as receive vehicle responses from performance of a test plan for the vehicles 600 (e.g., real-world vehicles). The vehicle software test environment management system 140 may request and/or obtain certification based on test results from virtual test vehicle 150 and vehicles 602. The vehicle software test environment management system 140 may send a request comprising test information of both the virtual test vehicle 150 and the real-world vehicles 100 and 502 to the certification destination as discussed above in FIG. 2C.

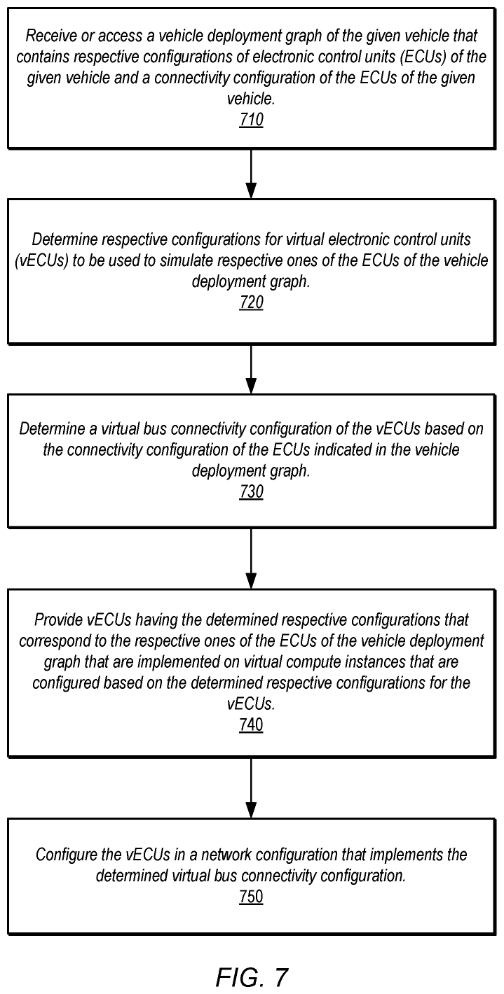

FIG. 7 illustrates a flowchart of operations performed by a vehicle software test environment management system to provide virtual electronic control units (vECUs) having a virtual bus connectivity configuration based on a vehicle deployment graph that may be used to simulate a vehicle, according to some embodiments.

At block 710, a vehicle software test environment management system receives or accesses a vehicle deployment graph of the given vehicle that contains respective configurations of electronic control units (ECUs) of the given vehicle and a connectivity configuration of the ECUs of the given vehicle. In some embodiments, the vehicle deployment graph may be a graphical representation of the various ECUs and communication network within the vehicle, wherein the nodes on the graph represent ECUs and the edges represent the communication bus links between the ECUs as discussed in FIG. 1.

At block 720, a vehicle software test environment management system determines respective configurations for virtual electronic control units (vECUs) to be used to simulate respective ones of the ECUs of the vehicle deployment graph. In some embodiments, the respective configurations determined by the vehicle software test environment management system may indicate types of processors to be used for vECUs as discussed in FIG. 3A.

At block 730, a vehicle software test environment management system determines a virtual bus connectivity configuration of the vECUs based on the connectivity configuration of the ECUs indicated in the vehicle deployment graph. In some embodiments, the virtual bus connectivity configuration may be determined to simulate in-vehicle traffic of multiple bus protocols as discussed in FIG. 1.

At block 740, a vehicle software test environment management system provides vECUs having the determined respective configurations that correspond to the respective ones of the ECUs of the vehicle deployment graph that are implemented on virtual compute instances that are configured based on the determined respective configurations for the vECUs. In some embodiments, the only a subset of ECUs may be simulated on the vECUs as discussed in FIG. 4.

At block 750, a vehicle software test environment management system configures the vECUs in a network configuration that implements the determined virtual bus connectivity configuration. In some embodiments, the virtual bus connectivity configuration may be implemented via simulated vehicle bus interfaces that translate signals to and from various protocols as discussed in FIG. 3C.

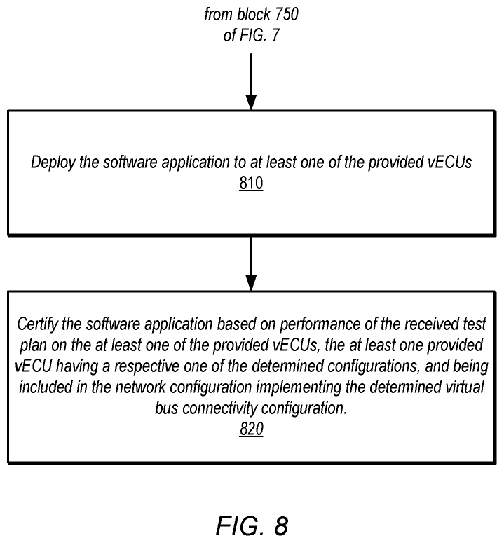

FIG. 8 illustrates a flowchart of operations performed by a vehicle software test environment management system to deploy a software application to a vECU and certify the software application based on performance results of a received test plan, according to some embodiments.

At block 810, a vehicle software test environment management system deploys the software application to at least one of the provided vECUs. In some embodiments, the vehicle software test environment management system may send signed serialized data chunks of a vehicle software to be deployed at a vehicle along with a deployment plan to deploy the software application as discussed in FIG. 2A.

At block 820, a vehicle software test environment management system certifies the software application based on performance results of the received test plan when performed on the at least one of the provided vECUs, the at least one provided vECU having a respective one of the determined configurations, and being included in the network configuration implementing the determined virtual bus connectivity configuration. In some embodiments, the vehicle software test environment management system may send a request that includes the response to a certification destination, and the certification destination may initiate its own separate internal certification workflow to determine whether the vehicle application should be certified and allowed to be deployed as discussed in FIG. 2C.

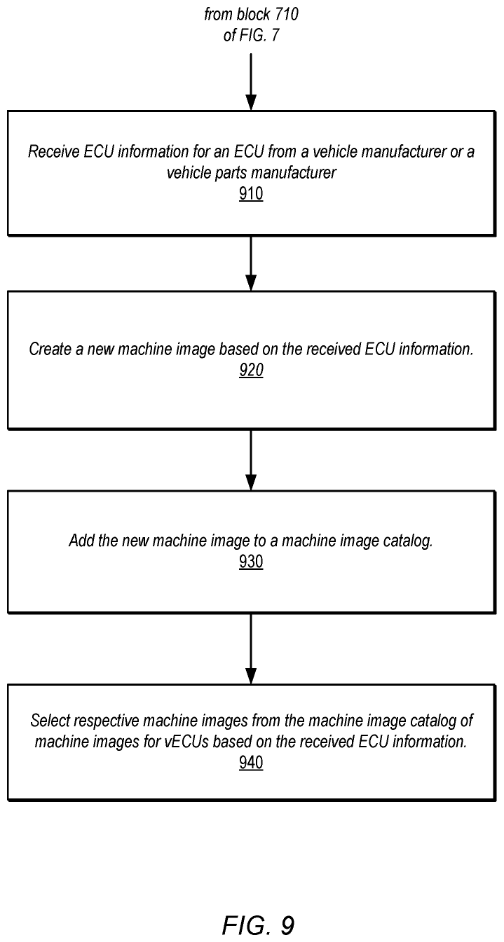

FIG. 9 illustrates a flowchart of operations performed by a vehicle software test environment management system to add a new machine image to a machine image catalog and select respective machine images from the machine image catalog to be implemented on vECUs, according to some embodiments.

At block 910, a vehicle software test environment management system receives ECU information for an ECU from a vehicle manufacturer or a vehicle parts manufacturer. In some embodiments, the ECU information may be information regarding a software environment of the ECU as discussed in FIG. 1 and FIG. 3A.

At block 920, a vehicle software test environment management system creates a new machine image based on the received ECU information. In some embodiments, the vehicle software test environment management system creates a new machine image to emulate a software environment of an ECU as discussed in FIG. 3A and FIG. 3B.

At block 930, a vehicle software test environment management system adds the new machine image to a machine image catalog. In some embodiments, the vehicle software test environment management system may modify or remove existing machine images in the machine image catalog as discussed in FIG. 3A.

At block 940, a vehicle software test environment management system selects respective machine images from the machine image catalog of machine images for vECUs based on the received ECU information. In some embodiments, the vehicle software test environment management system selects respective machine based on costs introduced in the emulation resource costs from translating a vehicle software's instructions set into the native instruction set in another compute environment.

### Example Computer System

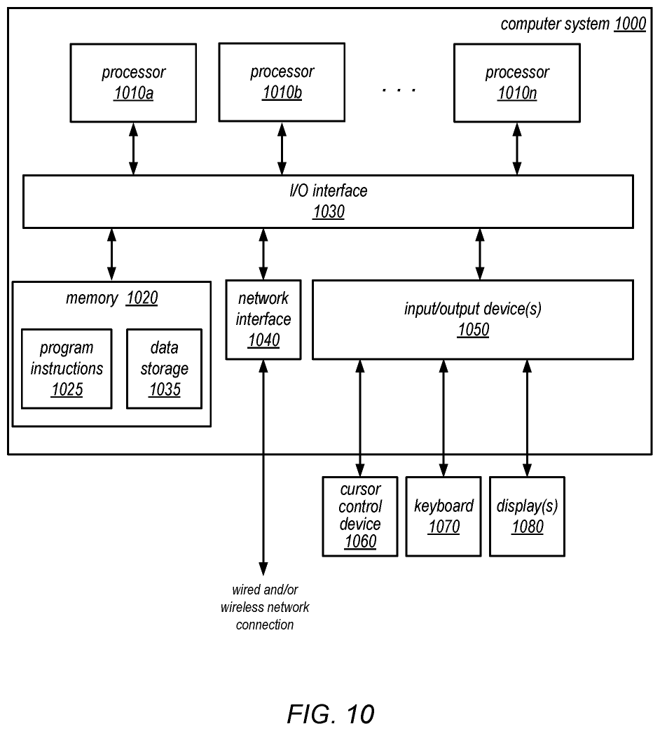

Any of various computer systems may be configured to implement processes associated with a vehicle software test environment management system or any other component of the above figures. For example, FIG. 10 illustrates a block diagram illustrating an example computer system that implements some or all of the techniques described herein, according to some embodiments. In various embodiments, the vehicle software test environment management system, the provider network that is used to deploy the vehicle software test environment management system and other cloud services, the operating system in a vehicle or device, or any other component of the above figures FIGS. 1-9 may each include one or more computer systems 1000 such as that illustrated in FIG. 10.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030. In some embodiments, computer system 1000 may be illustrative of servers implementing enterprise logic or that provide a downloadable application, while in other embodiments servers may include more, fewer, or different elements than computer system 1000.

In various embodiments, computing device 1000 may be a uniprocessor system including one processor or a multiprocessor system including several processors 1010a-1010n (e.g., two, four, eight, or another suitable number). Processors 1010a-1010n may include any suitable processors capable of executing instructions. For example, in various embodiments, processors 1010a-1010n may be processors implementing any of a variety of instruction set formats (ISAs), such as the x86, PowerPC, SPARC, or MIPS ISAs, or any other suitable ISA. In some embodiments, processors 1010a-1010n may include specialized processors such as graphics processing units (GPUs), application specific integrated circuits (ASICs), etc. In multiprocessor systems, each of processors 1010a-1010n may commonly, but not necessarily, implement the same ISA.

System memory 1020 may be configured to store program instructions and data accessible by processor(s) 1010a-1010n. In various embodiments, system memory 1020 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing one or more desired functions, such as those methods, techniques, and data described above, are shown stored within system memory 1020 as code (e.g., program instructions) 1025 and data storage 1035.

In one embodiment, I/O interface 1030 may be configured to coordinate I/O traffic between processors 1010a-1010n, system memory 1020, and any peripheral devices in the device, including network interface 1040 or other peripheral interfaces. In some embodiments, I/O interface 1030 may perform any necessary protocol, timing, or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, I/O interface 1030 may include support for devices attached via an automotive CAN bus, etc. In some embodiments, the function of I/O interface 1030 may be split into two or more separate components, such as a north bridge and a south bridge, for example. Also, in some embodiments, some or all of the functionality of I/O interface 1030, such as an interface to system memory 1020, may be incorporated directly into processors 1010a-1010n.

In some embodiments, the network interface 1040 may be coupled to I/O interface 1030, and one or more input/output devices 1050, such as cursor control device 1060, keyboard 1070, and display(s) 1080. In some cases, it is contemplated that embodiments may be implemented using a single instance of computer system 1000, while in other embodiments multiple such computer systems, or multiple nodes making up computer system 1000, may be configured to host different portions or instances program instructions as described above for various embodiments. For example, in one embodiment some elements of the program instructions may be implemented via one or more nodes of computer system 1000 that are distinct from those nodes implementing other elements.

Network interface 1040 may be configured to allow data to be exchanged between computing device 1000 and other devices associated with a network or networks. In various embodiments, network interface 1040 may support communication via any suitable wired or wireless general data networks, such as types of ethernet networks, cellular networks, Bluetooth networks, Wi-Fi networks, Ultra-wideband Networks, for example. Additionally, network interface 1040 may support communication via telecommunications/telephony networks such as analog voice networks or digital fiber communications networks, via storage area networks such as Fibre Channel SANs, or via any other suitable type of network and/or protocol.

In some embodiments, system memory 1020 may be one embodiment of a computer-readable (e.g., computer-accessible) medium configured to store program instructions and data as described above for implementing embodiments of the corresponding methods, systems, and apparatus. However, in other embodiments, program instructions and/or data may be received, sent, or stored upon different types of computer-readable media. Generally speaking, a computer-readable medium may include non-transitory storage media or memory media such as magnetic or optical media, e.g., disk or DVD/CD coupled to computing device 1000 via I/O interface 1030. One or more non-transitory computer-readable storage media may also include any volatile or nonvolatile media such as RAM (e.g., SDRAM, DDR SDRAM, RDRAM, SRAM, etc.), ROM, etc., that may be included in some embodiments, of computing device 1000 as system memory 1020 or another type of memory. Further, a computer-readable medium may include transmission media or signals such as electrical, electromagnetic, or digital signals, conveyed via a communication medium such as a network and/or a wireless link, such as may be implemented via network interface 1040. Portions or all of multiple computing devices such as that illustrated in FIG. 10 may be used to implement the described functionality in various embodiments; for example, software components running on a variety of different devices and servers may collaborate to provide the functionality. In some embodiments, portions of the described functionality may be implemented using storage devices, network devices, or various types of computer systems. The term “computing device” and “ECU” as used herein, refers to at least all these types of devices, and is not limited to these types of devices.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein (e.g., the functionality of the data transfer tool, various services, databases, devices and/or other communication devices, etc.).

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending, or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or nonvolatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

What is claimed is:

1. A system, comprising:
one or more computing devices configured to implement a vehicle software test environment configured to:
receive a software application to be certified;
receive or access a test plan for certifying the software application for use in a given vehicle;
receive or access a vehicle deployment graph of the given vehicle, wherein the vehicle deployment graph comprises respective configurations of one or more electronic control units (ECUs) of the given vehicle and a connectivity configuration of the ECUs of the given vehicle;
determine respective configurations for virtual electronic control units (vECUs) to be used to simulate respective ones of the ECUs of the vehicle deployment graph;
determine virtual bus connectivity configuration for the vECUs based on the connectivity configuration of the ECUs indicated in the vehicle deployment graph;
provide computing resources configured as the vECUs having the determined respective configurations that correspond to the respective ones of the ECUs of the vehicle deployment graph, wherein the computing resources are implemented using virtual compute instances that are configured based on the determined respective configurations for the vECUs, and wherein the computing resources are further configured in a network configuration that implements the determined virtual bus connectivity configuration;
deploy the software application to at least one of the provided computing resources configured as a vECU; and
perform the received test plan to certify the software application for use in the given vehicle, wherein the received test plan is performed using the provided computing resources configured as the vECUs configured in the virtual bus configuration.

2. The system of claim 1, wherein to perform the received test plan, the vehicle software test environment is further configured to:
receive recorded signals of one or more ECUs of the given vehicle, or a vehicle having a similar configuration as the given vehicle;
apply the received recorded signals to respective ones of one or more of the vECUs via virtual hooks of the one or more of the vECUs; and
determine that a resulting response of the software application is within a threshold range as provided in the test plan.

3. The system of claim 2, wherein to perform the receive test plan the vehicle software test environment is configured to:
apply a portion of the received recorded signals corresponding to a first set of moments in time to the respective ones of the one or more of the vECUs via the virtual hooks;
receive sensor outputs from the vECUs based on the application of the received recorded signals for the first set of moments in time;
modify a second portion of the recorded signals corresponding to a second set of moments in time based on the received sensor outputs from the vECUs; and
apply the modified second portion of the recorded signals to the respective ones of the one or more of the vECUs via the virtual hooks for the second set of moments in time.

4. The system of claim 1, wherein the vehicle software test environment is further configured to:
record a response of the software application during the performance of the test plan; and
perform the received test plan multiple times using the same received recorded signals, wherein the software application is non-determinists, wherein performance of the test plan multiple times indicates a range of performance levels for the non-deterministic software application, and wherein a threshold range for certification for the non-deterministic software application is based on the range of performance levels.

5. A method, comprising:
receiving or accessing a vehicle deployment graph of a given vehicle, wherein the vehicle deployment graph comprises respective configurations of one or more electronic control units (ECUs) of the given vehicle and a connectivity configuration of the ECUs of the given vehicle;
determining respective configurations for one or more virtual electronic control units (vECUs) to be used to simulate one or more respective ones of the ECUs of the vehicle deployment graph; and
providing one or more vECUs having the determined respective configurations for use in certifying a software application to be implemented at the given vehicle, wherein the provided one or more vECUs are implemented on one or more virtual compute instances that are configured based on the determined respective configurations for the one or more vECUs.

6. The method of claim 5, wherein determining the respective configurations for the one or more vECUs comprises:
determining respective machine images for the one or more vECUs, wherein the respective machine images emulate respective software environments of the respective ones of the ECUs indicated in the vehicle deployment graph; and
determining respective instance types of the one or more virtual compute instances to be used to implement the vECUs.

7. The method of claim 6, wherein determining the respective instance types of the one or more virtual compute instances to be used to implement the vECUs comprises:
determining the respective instance types based on respective processor types of the one or more ECUs indicated in the vehicle deployment graph; or
determining the respective instance types based on the respective machine images determined to be used for the one or more vECUs.

8. The method of claim 6, wherein providing the one or more vECUs, having the determined respective configurations, implemented on the one or more the virtual compute instances comprises:
provisioning the one or more virtual compute instances of the determined instance types based on the respective processor types of the ECUs indicated in the vehicle deployment graph; and
booting the one or more virtual compute instances using the determined respective machine images.

9. The method of claim 6, wherein determining the respective machine images for the one or more vECUs comprises:
selecting the respective machine images from a machine image catalog comprising machine images for ECUs used in a plurality of types of vehicles.

10. The method of claim 6, further comprising:
receiving ECU information for an ECU from a vehicle manufacturer or a vehicle parts manufacturer;
creating a new machine image based on the received ECU information; and
adding the new machine image to the machine image catalog.

11. The method of claim 5, further comprising:
determining the virtual bus connectivity configuration for the vECUs based on the connectivity configuration of the ECUs indicated in the vehicle deployment graph; and
configuring the provided vECUs in a network configuration that implements the determined virtual bus connectivity configuration in a virtual private cloud.

12. The method of claim 11, wherein configuring the provided vECUs according to the virtual bus connectivity configuration comprises:
providing respective private network addresses to the vECUs implemented on the virtual private cloud; and
configuring simulated vehicle bus interfaces for the respective vECUs to send and receive messages via the virtual private cloud, using the provided private network addresses, to simulate in-vehicle bus traffic.

13. The method of claim 12, further comprising:
receiving the software application to be certified;
receiving or accessing a test plan for certifying the software application for use in the given vehicle;
deploying the software application to at least one of the provided vECUs; and
performing the received test plan to certify the software application for use in the given vehicle, wherein the received test plan is performed using the provided computing resources configured as the vECUs configured in the virtual bus configuration.

14. The method of claim 13, further comprising:
performing a second test plan to certify the software application for use in the given vehicle, wherein the second test plan is performed on a real-world vehicle.

15. The method of claim 5, further comprising,
deploying the software application to at least one of the provided one or more vECUs via an over-the-air (OTA) service, wherein the OTA service is configured to deploy the software application to the one or more vECUs and the ECUs of the given vehicle.

16. The method of claim 5, further comprising:
receiving a test plan for certifying the software application for use in the given vehicle;
performing the received test plan, wherein the performing comprises:
receiving recorded signals of one or more ECUs of the given vehicle, or a vehicle having a similar configuration as the given vehicle;
applying the received recorded signals to respective ones of the vECUs via virtual hooks of the one or more of the vECUs; and
determining that a resulting response of the software application is within a threshold range as provided in the test plan.

17. The method of claim 16, wherein the performing the received test plan comprises:
performing the received test plan, wherein the performing comprises:
modifying the recorded signals of the one or more ECUs based on downstream changes from the software application.

18. The method of claim 16, further comprising:
recording the response of the software application; and
performing the received test plan to certify the software application for use in the given vehicle, wherein the received test plan is performed using the provided computing resources configured as the vECUs configured in the virtual bus configuration multiple times using the same recorded signals, wherein the software application is non-deterministic.

19. One or more non-transitory, computer-readable storage media, storing program instructions that when executed on or across one or more processors cause the one or more processors to:
receive or accessed a vehicle deployment graph of a given vehicle, wherein the vehicle deployment graph comprises respective configurations of one or more electronic control units (ECUs) of the given vehicle and a connectivity configuration of the ECUs of the given vehicle;
determine respective configurations for one or more virtual electronic control units (vECUs) to be used to simulate one or more respective ones of the ECUs of the vehicle deployment graph; and
provide one or more vECUs having the determined respective configurations for use in certifying a software application to be implemented at the given vehicle, wherein the provided one or more vECUs are implemented on one or more virtual compute instances that are configured based on the determined respective configurations for the one or more vECUs.

20. The one or more non-transitory, computer-readable storage media of claim 19, wherein the program instructions that when executed cause the one or more processors to:
receive the software application to be certified;
receive a test plan for certifying the software application for use in the given vehicle;
cause the software application to be deployed to at least one of the provided vECUs; and
certify the software application based on performance of the received test plan on the at least one of the provided vECUs, the at least one provided vECU having a respective one of the determined configurations, and being included in the network configuration implementing the determined virtual bus connectivity configuration.
